(19) United States
(12) Patent Application Publication
(10) Pub. No.: US 2007/0097080 A1
(43) Pub. Date: May 3, 2007

(54) Wireless keyboard for chair

(76) Inventor: Kingsley A. Whipple, Evergreen, CO (US)

Correspondence Address: BARBER LEGAL, P.O. BOX 16220, GOLDEN, CO, 80402-6004, US

(21) Appl. No.: 11/266,134

(22) Filed: Nov. 2, 2005

(51) Int. Cl. G09G 5/00

(52) U.S. Cl. 345/168

(57) ABSTRACT

A wireless computer keyboard having a support, a keypad, an analog input device, and a hinged anchor allowing at least one degree of rotational motion of the device relative to a chair armrest to which it is secured by the hinged anchor. In a first position it rests in front of a user seated in the chair, in a second position it rests on the outside of the chair arm, out of the user's way. The anchor may have a set screw clamping it securely to the chair, or a set of jaws with grips allowing to easily be attached and removed, allowing retrofit to existing chairs. In embodiments the device may be a chair having attached to one arm rest a support, a keypad, an analog input device, and a hinged anchor allowing at least one degree of rotational motion of the device.

### FIELD OF THE INVENTION

This invention relates generally to computer keyboard devices, and specifically to a computer keyboard device for a chair arm.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

Computer keyboards generally are attached to a computer by a wire or cable which limits the freedom of position of a user. One recent attempt to free users from this limitation is the wireless keyboard in which the computer and keyboard communicate by means of infra-red, radio frequency, visible light, etc. A transmitter in the keyboard sends a signal to the computer to communicate what the user is doing with the keyboard and/or analog input device (this mouse, touch pad, joystick, etc may be considered to be a separate device or part of the keypad.

However, the problem of placement of the keyboard remains. Proper typists generally place the keyboard on a low table in front of a computer monitor screen: some such low tables have a special shelf which may extend for use, with the keyboard set upon the shelf and thus stowed away when not in use. Less formal typists rest the keyboard on their laps during use, an advantage for certain very common types of eye conditions but a nuisance in that the keyboard slips off the lap, moves when the user moves their legs and so on.

It would be advantageous to provide a device which allows a wireless keyboard to be used without resting on the user's lap, but at a location removed from the computer monitor screen location.

It would further be advantageous to provide a device which allows the attachment of the keyboard to an office chair.

It would further be advantageous to provide a device offering at least two keyboard positions: generally in front of the user when seated, and generally out of the user's way for entry and exit from the chair.

The present invention provides these advantages and more by providing a keyboard device conveniently and rotatably attached to a chair arm.

### SUMMARY OF THE INVENTION

General Summary

The present invention teaches a wireless computer keyboard having a support, a keypad, an analog input device, and a hinged anchor allowing at least one degree of rotational motion of the device relative to a chair armrest to which it is secured by the hinged anchor. The keyboard may assume a first position in which it rests generally in front of a user seated in the chair, or a second position in which it rests on the outside of the chair arm, out of the user's way for standing up, sitting down, leaning forward, etc.

The anchor may have a set screw to clamp it securely to the chair, or it may have a set of jaws with grips allowing to easily be attached and removed. By this structure the device may be easily retrofitted to existing chairs having arms.

In an alternative embodiment, the device may be a chair having attached to one arm rest, a support, a keypad, an analog input device, and a hinged anchor allowing at least one degree of rotational motion of the device relative to the chair armrest.

Summary in Reference to Claims

It is therefore a first aspect, advantage, objective and embodiment of the invention to provide a wireless computer keyboard for use with a computer by a computer user seated in a chair having an armrest having sides distal and proximate such computer user seated in such chair, the keyboard comprising:
a keypad having a plurality of keys;
an analog input device;
an operative wireless connection allowing transfer of data from the keypad and the analog input device to such computer without physical electrical connection therebetween;
a support having a first surface to which the keypad and analog input device are secured;
a hinged anchor attached to the support, the hinged anchor also attached to such armrest;
the hinged anchor allowing rotational motion of the support from and to a first position in which the support, keypad and analog input device rest generally in front of such user seated in such chair.

It is therefore a second aspect, advantage, objective and embodiment of the invention to provide a wireless computer keyboard wherein the hinged anchor further allows rotational motion of the support from and to a second position in which the support, keypad and analog input device rest generally on the side of such armrest distal from such user seated in such chair.

It is therefore a third aspect, advantage, objective and embodiment of the invention to provide a wireless computer keyboard wherein the support further comprises: a lower surface, the hinged anchor attached to the support at the lower surface.

It is therefore another aspect, advantage, objective and embodiment of the invention to provide a wireless computer keyboard further comprising:
a swivel allowing a second degree of rotational motion of the support, keypad and analog input device relative to such armrest.

It is therefore another aspect, advantage, objective and embodiment of the invention to provide a wireless computer keyboard wherein the analog input device is a part of the keypad.

It is therefore another aspect, advantage, objective and embodiment of the invention to provide a wireless computer keyboard wherein the analog input device further comprises:
a mat secured to the support, and
a mobile device independent of the keypad, the mobile device secured to an attachment,
the attachment secured to the support, whereby the mobile device remains attached to the support when the support is rotated relative to the armrest.

It is therefore another aspect, advantage, objective and embodiment of the invention to provide a wireless computer keyboard further comprising:
a wrist support disposed upon the support in a location between the user and the keypad.

It is therefore another aspect, advantage, objective and embodiment of the invention to provide a wireless computer keyboard wherein the anchor further comprises:
at least one clamp having an aperture dimensioned and configured to engage such chair arm;
at least one set screw passing through such clamp, the set screw having a tightened position in which the clamp physically engages such chair arm to prevent motion of the clamp relative to the chair arm.

It is therefore another aspect, advantage, objective and embodiment of the invention to provide a wireless computer keyboard wherein the anchor further comprises:
at least one set of open able and close able jaws dimensioned and configured to engage such chair arm, the jaws having a spring urging the jaws into a closed position in which the jaws physically engage such chair arm to prevent motion of the jaws relative to the chair arm.

It is therefore another aspect, advantage, objective and embodiment of the invention to provide a wireless computer keyboard wherein the jaws further comprise:
at least one set of grips attached to the jaws, the grips having a relaxed position in which the jaws are urged into the closed position.

It is therefore yet another aspect, advantage, objective and embodiment of the invention to provide a chair for a user comprising:
an armrest;
a hinged anchor attached to the armrest;
a support attached to the hinged anchor, the hinged anchor allowing rotational motion of the support relative to the armrest from and to a first position in which the support rests generally in front of such user seated in the chair, the support having an upper surface when in such first position;
a keypad having a plurality of keys attached to the first surface;
an analog input device attached to the first surface;
an operative wireless transmitter allowing transmission of data from the keypad and the analog input device.

It is therefore another aspect, advantage, objective and embodiment of the invention to provide a chair wherein the hinged anchor further allows rotational motion of the support from and to a second position in which the support, keypad and analog input device rest generally on the side of the armrest distal from a user seated in the chair.

It is therefore another aspect, advantage, objective and embodiment of the invention to provide a chair wherein the operative wireless transmitter further comprises one member selected from the group consisting of:
radio frequency transmitters, infra-red transmitters, visible light transmitters, and combinations thereof.

It is therefore another aspect, advantage, objective and embodiment of the invention to provide. a chair wherein the support further comprises: a lower surface, the hinged anchor attached to the support at the lower surface.

It is therefore another aspect, advantage, objective and embodiment of the invention to provide a chair further comprising:
a swivel allowing a second degree of rotational motion of the support, keypad and analog input device relative to the armrest.

It is therefore another aspect, advantage, objective and embodiment of the invention to provide a chair wherein the anchor further comprises:
at least one clamp having an aperture dimensioned and configured to engage such chair arm;
at least one set screw passing through such clamp, the set screw having a tightened position in which the clamp physically engages such chair arm to prevent motion of the clamp relative to the chair arm.

It is therefore another aspect, advantage, objective and embodiment of the invention to provide a chair wherein the anchor further comprises:
at least one set of open able and close able jaws dimensioned and configured to engage such chair arm, the jaws having a spring urging the jaws into a closed position in which the jaws physically engage such chair arm to prevent motion of the jaws relative to the chair arm.

It is therefore another aspect, advantage, objective and embodiment of the invention to provide a chair wherein the jaws further comprise:
at least one set of grips attached to the jaws, the grips having a relaxed position in which the jaws are urged into the closed position.

It is therefore another aspect, advantage, objective and embodiment of the invention to provide a chair wherein the anchor and chair arm are a unitary body.

### BRIEF DESCRIPTION OF THE DRAWINGS

FIG. 1 is a side view of a chair keyboard according to a first embodiment of the invention, in a stowed position.

FIG. 2 is a perspective view of a second embodiment of the device in an intermediate position.

FIG. 3 is a perspective view of a third embodiment of the device in a folded away position.

FIG. 4 is a perspective view of the third embodiment of the device in the position of use.

FIG. 5 is a perspective view of a PRIOR ART chair the device might be retrofitted to.

FIG. 6 is a top platform view of a fourth embodiment of the device.

FIG. 7 is a bottom view of a fifth embodiment of the device having a screw on attachment to a chair arm.

FIG. 8 is a bottom view of a sixth embodiment of the device having a quick release grip attachment to a chair arm.

FIG. 9 is a top view of a seventh embodiment of the device in a stowed position.

FIG. 10 is a top view of an eight embodiment of the device in a position of use.

FIG. 11 is a front view of a ninth embodiment of the device in a position of use.

FIG. 12 is a side view of a tenth embodiment of the device in a position of use.

### INDEX TO THE REFERENCE NUMERALS

| | |
|---|---|
| Chair embodiment | 200 |
| Computer keypad | 202 |
| Mouse pad | 204 |
| Swivel frame member | 206 |
| Chair arm | 208 |
| Chair | 302 |
| Arm | 304 |
| Keyboard (undersurface) | 306 |
| Anchor | 308 |
| Chair | 402 |
| Arm | 404 |
| Keyboard | 406 |
| Chair | 502 |
| Chair keyboard | 602 |
| Wrist rest | 604 |
| Keypad | 606 |
| Upper surface | 608 |
| Mouse pad | 610 |
| Mouse retainer | 612 |
| Chair keyboard | 702 |
| Lower surface | 708 |
| Base plate | 720 |
| Hinge | 722 |
| Swivel | 724 |
| First chair arm cuff | 726 |
| Second chair arm cuff | 728 |
| Aperture | 730 |
| Set screw | 732 |
| Knob | 734 |
| Chair keyboard | 802 |
| Under surface | 804 |
| Base plate | 820 |
| Hinge | 822 |
| Swivel | 824 |
| Mount | 840 |
| Jaws | 842 |
| Grips | 844 |
| Chair | 902 |
| Keyboard | 904 |
| Anchor | 906 |
| Armrest | 908 |
| Chair | 1002 |
| Armrest | 1004 |
| Horizontal top surface | 1006 |
| Computer keyboard | 1008 |
| Wrist support | 1010 |
| Computer mousepad | 1012 |

### DETAILED DESCRIPTION

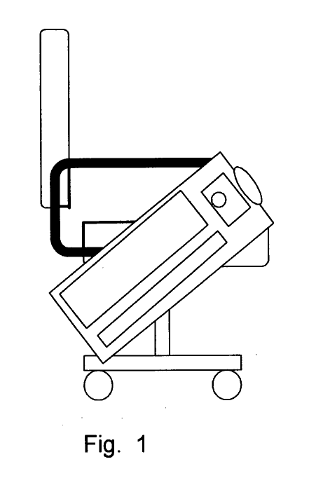

FIG. 1 is a side view of a chair keyboard according to the invention, showing how the device may be swung at an angle down and backwards so as to be out of the way, and that the device is connected to the chair arm. The device thus sits outside the arms of the chair on one side.

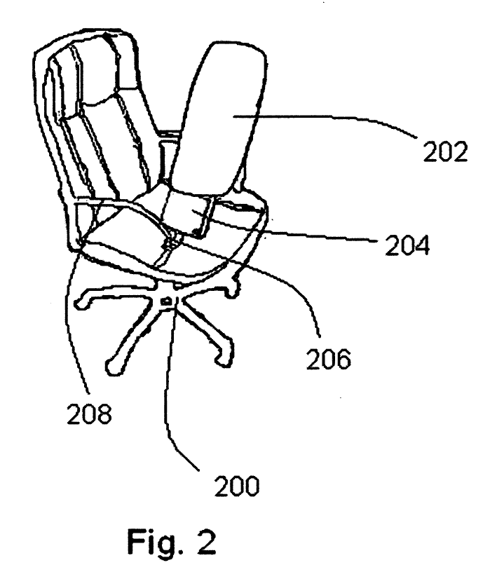

FIG. 2 is a perspective view of a second embodiment of the device in an intermediate position. Chair embodiment 200 has computer keypad 202 which may be a standard 83+ key computer keyboard, 100+ key computer keyboard and so on: keyboards having 120+ keys are common. Individual keys are omitted from the diagrams for the sake of clarity. Such keyboards may also include analog input devices such as mouses, touch pads, bars, pointers, joysticks and so on, or a separate mouse pad 204 may be included as shown for use by a standard computer mouse or similar independently mobile analog input device.

Swivel frame member 206 may project from or be part of chair arm 208 and may be manufactured as part of the chair embodiment 302, in a unitary body not separable therefrom.

While the device is pictured in an intermediate position, it may be appreciated that it may swing, rotating from a first position generally in front of a user seated in the chair to a second position on the “outside” portions of the chair, generally defined as the sides of the chair arms 208 which is distal from the seated user.

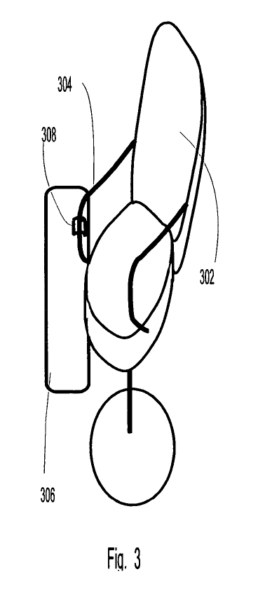

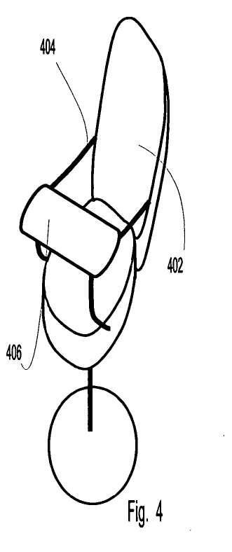

FIG. 3 is a perspective view of a third “retrofitted” embodiment of the device in a folded away position. Arm 304 supports the device as it hangs on the outer side of the chair arm. FIG. 4 is a perspective view of the third embodiment of the device in the position of use.

Chair 402 has arm/armrest 404 to which keyboard 406 has been attached by a hinged anchor. As may be seen, the device may assume at least two positions (and in embodiments a range of positions in between), the use position and the non-use position.

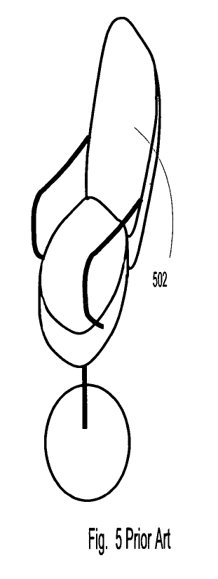

FIG. 5 is a perspective view of a PRIOR ART chair to which the device might be retrofitted. Chair 502 is a generally standard office chair. By use of retrofitting embodiments of the invention, a wide range of customers who may not wish to invest in the chair embodiments are enabled to use the invention.

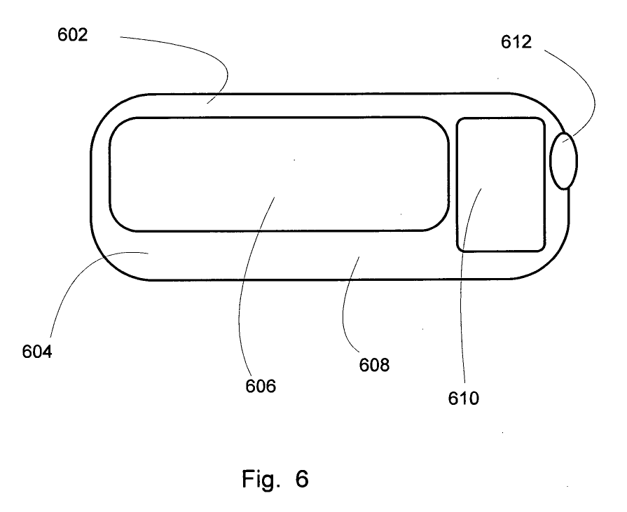

FIG. 6 is a top platform view of a fourth embodiment of the device. Chair keyboard 602 has an upper surface 608, as well as a lower surface not seen in this diagram. A portion of the upper surface 608 may comprise wrist rest 604. Wrist rests have proven ergonomic benefits to computer users. Another embodiment of a wrist rest may comprise an elevated and soft or conformable surface disposed upon upper surface 608 at the same location as wrist rest 604.

Keypad 606 may include an analog input device, or separate mouse pad 610 may be employed. Mouse retainer 612 may be employed as well. This may comprise a small “mouse garage” into which a mouse is placed after use and before the keyboard is rotated, or a small retainer such as a clip or the like which holds the mouse cable, and thus the mouse, close to the chair keyboard 602 during rotations. Since a typical cable mounted clip would allow a mouse to suffer minimal motion and small impacts during rotation, the presently preferred embodiment and best mode now contemplated comprises a keyboard having a “built-in” analog input device such as a pointer, touch pad or the like instead of a mouse.

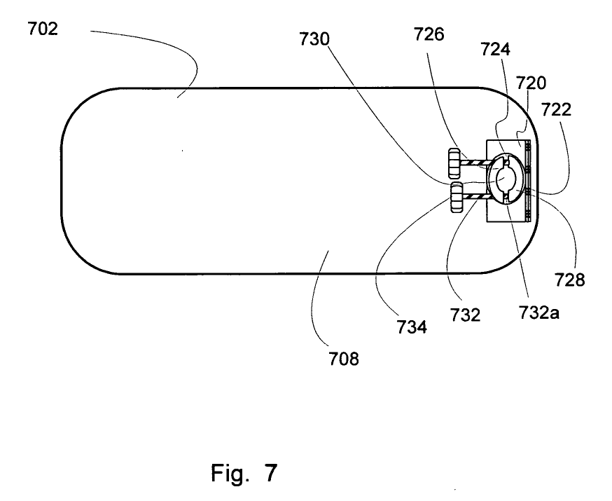

FIG. 7 is a bottom view of a fifth embodiment of the device having a screw on attachment to a chair arm. Chair keyboard 702 has lower surface 708 as well as an upper surface not depicted in FIG. 7. Base plate 720 connects swivel 724 to lower surface 708. Hinge 722 connects swivel 724 to first chair arm cuff 726 and second chair arm cuff 728.

Aperture 730 passes through first and second cuffs 726, 728. Set screw 732 is threaded externally and passes through internally threaded cuff 726 and into cuff 728. When knob 734 is turned in a first direction, the set screw 732 will rotate into a tightened position in which the cuffs 726, 728 are urged together, thus firmly affixing the device to any chair arm disposed therebetween in aperture 730, which may be dimensioned and configured to engage a chair arm. When knob 734 is turned in a second direction, the set screw 732 will rotate into a loosened position in which the cuffs 726, 728 are no longer urged together and may be urged apart. By this means, a secure attachment to a chair arm may be secured, or the device may be removed for retrofit to a different chair arm.

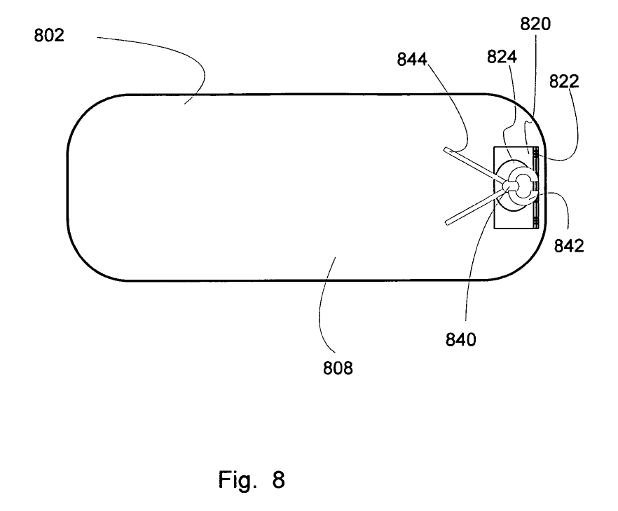

FIG. 8 is a bottom view of a sixth embodiment of the device having a quick release grip attachment to a chair arm. Chair keyboard 802 has under surface 804, base plate 820, hinge 822, and swivel 824 may be much as described in reference to FIG. 7. Note that the “ordering” of attachment of the components to each other, and thus their exact arrangement, may be altered in any embodiment. For example, the swivel 824 may connect baseplate 820 to lower surface 808 while baseplate 820 may connect swivel 824 to hinge 822. The swivel may be disposed in yet other embodiments upon the “armrest” side of the hinge, additional base plates may be used to provide additional support and so on.

In the presently preferred embodiment and best mode presently contemplated for carrying out the invention, mount/spring 840 urges a pair of jaws 842 into a closed position and urges a pair of grips 844 into an open or relaxed position, such that the aperture between the jaws physically engages a chair arm. This embodiment of the invention allows convenient removal of the device from one chair and attachment to another chair.

Mount/spring 840, is pictured extending away from the chair arm in the “inwards” direction (proximate the user) but for reasons of comfort and convenience may instead extend outwards (distal the user) so as to not extend under the keyboard 802 during use. Spring 840 may also swivel freely by itself or upon swivel 824.

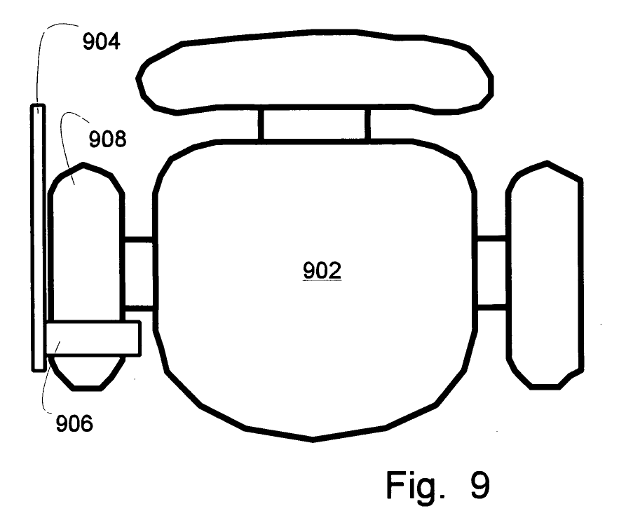

FIG. 9 is a top view of a seventh embodiment of the device in a stowed position. Chair 902 has armrest 908 to which the chair keyboard is attached by anchor 906. Swung out of the way, anchor 906 does not move, but the keyboard falls downwards at an angle towards the back, outside of the arms of the chair, so as to be almost entirely out of the way of the keyboard user.

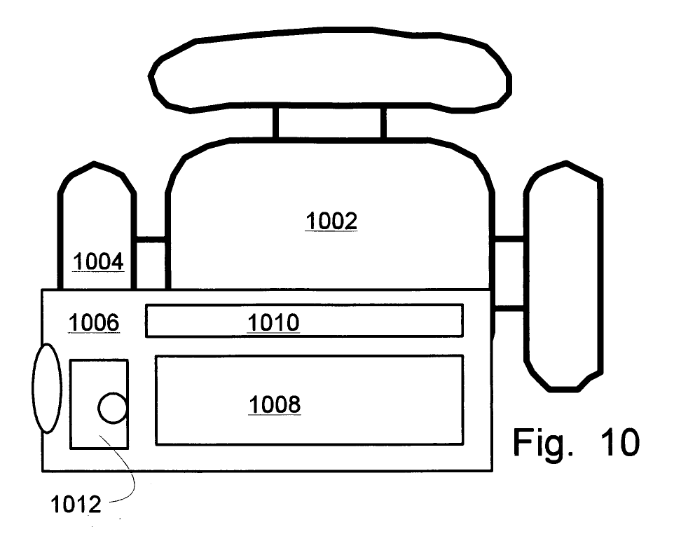

FIG. 10 is a top view of an eight embodiment of the device in a position of use. In this embodiment, chair 1002 has armrest 1004 much as previously described, but horizontal top surface 1006 (which may be the top of a support made of metal, plastic, polymer, wood or combinations thereof) has attached to it standard computer components acquired by the user. Keyboard 1008, wrist support 1010 and mousepad 1012 may all be safely secured to the device by attachments provided with the device or by the user.

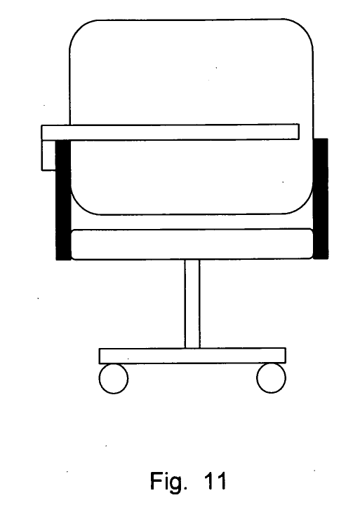

FIG. 11 is a front view of a ninth embodiment of the device in a position of use. In this embodiment, the device may not entirely traverse the distance from one chair arm to the next, however in alternative embodiments, the device may pass from arm to arm, thus realizing greater support.

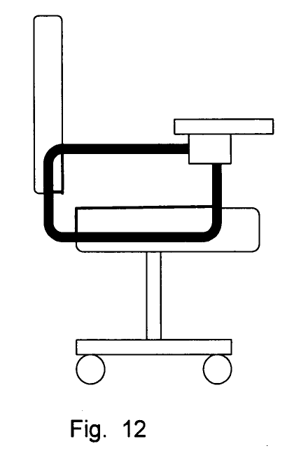

FIG. 12 is a side view of a tenth embodiment of the device in a position of use. As the keyboard anchor may be moved towards the front or back of the chair along the arm, or by means of other devices allowing the anchor to remain still but the keyboard to move, the device may be moved forward or backwards to suit individual users. The angle of the device may be altered as well, in pitch, yaw or roll as needed for user comfort, and the anchor mechanism may also allow adjustment of the height of the device.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A wireless computer keyboard for use with a computer by a computer user seated in a chair having an armrest having sides distal and proximate such computer user seated in such chair, the keyboard comprising:
a keypad having a plurality of keys;
an analog input device;
an operative wireless connection allowing transfer of data from the keypad and the analog input device to such computer without physical electrical connection therebetween;
a support having a first surface to which the keypad and analog input device are secured;
a hinged anchor attached to the support, the hinged anchor also attached to such armrest;
the hinged anchor allowing rotational motion of the support from and to a first position in which the support, keypad and analog input device rest generally in front of such user seated in such chair.

2. The wireless computer keyboard of claim 1, wherein the hinged anchor further allows rotational motion of the support from and to a second position in which the support, keypad and analog input device rest generally on the side of such armrest distal from such user seated in such chair.

3. The wireless computer keyboard of claim 1, wherein the support further comprises: a lower surface, the hinged anchor attached to the support at the lower surface.

4. The wireless computer keyboard of claim 1, further comprising:
a swivel allowing a second degree of rotational motion of the support, keypad and analog input device relative to such armrest.

5. The wireless computer keyboard of claim 1, wherein the analog input device is a part of the keypad.

6. The wireless computer keyboard of claim 1, wherein the analog input device further comprises:
a mat secured to the support, and
a mobile device independent of the keypad, the mobile device secured to an attachment, the attachment secured to the support, whereby the mobile device remains attached to the support when the support is rotated relative to the armrest.

7. The wireless computer keyboard of claim 1, further comprising:
a wrist support disposed upon the support in a location between the user and the keypad.

8. The wireless computer keyboard of claim 1, wherein the anchor further comprises:
at least one clamp having an aperture dimensioned and configured to engage such chair arm;
at least one set screw passing through such clamp, the set screw having a tightened position in which the clamp physically engages such chair arm to prevent motion of the clamp relative to the chair arm.

9. The wireless computer keyboard of claim 1, wherein the anchor further comprises:
at least one set of open able and close able jaws dimensioned and configured to engage such chair arm, the jaws having a spring urging the jaws into a closed position in which the jaws physically engage such chair arm to prevent motion of the jaws relative to the chair arm.

10. A wireless computer keyboard of claim 9, wherein the jaws further comprise:
at least one set of grips attached to the jaws, the grips having a relaxed position in which the jaws are urged into the closed position.

11. A chair for a user comprising:
an armrest;
a hinged anchor attached to the armrest;
a support attached to the hinged anchor, the hinged anchor allowing rotational motion of the support relative to the armrest from and to a first position in which the support rests generally in front of such user seated in the chair, the support having an upper surface when in such first position;
a keypad having a plurality of keys attached to the first surface;
an analog input device attached to the first surface;
an operative wireless transmitter allowing transmission of data from the keypad and the analog input device.

12. The chair of claim 11, wherein the hinged anchor further allows rotational motion of the support from and to a second position in which the support, keypad and analog input device rest generally on the side of the armrest distal from a user seated in the chair.

13. The chair of claim 11, wherein the operative wireless transmitter further comprises one member selected from the group consisting of:
radio frequency transmitters, infra-red transmitters, visible light transmitters, and combinations thereof.

14. The chair of claim 11, wherein the support further comprises: a lower surface, the hinged anchor attached to the support at the lower surface.

15. The chair of claim 11, further comprising:
a swivel allowing a second degree of rotational motion of the support, keypad and analog input device relative to the armrest.

16. The chair of claim 11, wherein the anchor further comprises:
at least one clamp having an aperture dimensioned and configured to engage such chair arm;
at least one set screw passing through such clamp, the set screw having a tightened position in which the clamp physically engages such chair arm to prevent motion of the clamp relative to the chair arm.

17. The chair of claim 11, wherein the anchor further comprises:
at least one set of open able and close able jaws dimensioned and configured to engage such chair arm, the jaws having a spring urging the jaws into a closed position in which the jaws physically engage such chair arm to prevent motion of the jaws relative to the chair arm.

18. The chair of claim 17, wherein the jaws further comprise:
at least one set of grips attached to the jaws, the grips having a relaxed position in which the jaws are urged into the closed position.

19. The chair of claim 11, wherein the anchor and chair arm are a unitary body.
